(19) United States
(12) Patent Application Publication
(10) Pub. No.: US 2010/0231813 A1
(43) Pub. Date: Sep. 16, 2010

(54) COLD CATHODE TUBE LAMP, LIGHTING DEVICE FOR DISPLAY DEVICE, DISPLAY DEVICE, AND TELEVISION RECEIVING DEVICE

(75) Inventor: Yoshiki Takata, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/679,032

(22) PCT Filed: Apr. 9, 2008
(86) PCT No.: PCT/JP2008/056980

§ 371 Date: Mar. 19, 2010

(30) Foreign Application Priority Data
Sep. 21, 2007 (JP) 2007-245469

(51) Int. Cl. H04N 3/14; G09G 3/36; H01J 61/00; H01J 61/067

(52) U.S. Cl. 348/790; 345/102; 313/567; 313/568; 348/E03.016

(57) ABSTRACT

This cold cathode tube lamp comprises a glass tube (11) into which at least a rare gas is filled, a pair of first electrodes (21, 22) disposed to face each other at both inner end portions of the glass tube (11) and composed of cylinder-shaped first cylindrical portions (21a, 22a) with openings at one ends and first bottom portions (21b, 22b) closing the other ends of the first cylindrical portions (21a, 22a), and second electrodes (41, 42) provided in the respective first electrodes (21, 22). The second electrodes (41, 42) include at least cylinder-shaped second cylindrical portions (41a, 42a) with openings at each one end thereof. The second electrodes (41, 42) are disposed such that the second cylindrical portions (41a, 42a) are a predetermined distance away from the respective first cylindrical portions (21a, 22a) of the first electrodes (21, 22).

### TECHNICAL FIELD

The present invention relates to a cold-cathode tube lamp, and more particularly, to a cold-cathode tube lamp that includes a cup-shape cold-cathode tube electrode.

### BACKGROUND ART

Conventionally, a cold-cathode tube lamp is used as a light source for various devices. For example, because a cold-cathode tube lamp has low power consumption and a long life as a light source, it is used as a light source (backlight) for a liquid crystal display device and the like.

FIG. 11 is a sectional view showing a structure of a conventional cold-cathode tube lamp. The structure of the conventional cold-cathode tube lamp is described with reference to FIG. 11. The conventional cold-cathode tube lamp, as shown in FIG. 11, includes: a glass tube 401 that has an outer diameter of about 1.5 mm to about 4.0 mm (inner diameter: about 1.0 mm to about 3.0 mm); and an electrode 402 and an electrode 403 that constitute a pair of cold cathodes disposed at both inner end portions of the glass tube 401 opposite to each other. The electrode 402 and the electrode 403, as shown in FIG. 11, have a cup shape that has an outer diameter of about 1.2 mm to about 2.0 mm and a total length of about 4.0 mm to about 7.0 mm. Further, as shown in FIG. 11, a lead terminal 404 and a lead terminal 405 are connected with the electrode 402 and the electrode 403, respectively; and the other ends of the lead terminal 404 and the lead terminal 405 are led out to outside of the glass tube 401. And, the glass tube 401 is closed air-tightly and sealed hermetically by the lead terminal 404 and the lead terminal 405. Here, although not shown, a fluorescent material is coated on an inner wall of the glass tube 401; and a rare gas such as argon, neon or the like and mercury are filled in the glass tube 401 as discharge gases.

When an electric voltage is applied across the electrode 402 and the electrode 403 of the above cold-cathode tube lamp via the lead terminal 404 and the lead terminal 405, electrons that are present slightly in the glass tube 401 are attracted to and collide with the electrode. Here, secondary electrons are emitted from the electrode with which the electrons collide and electric discharge begins; and the emitted electrons collide with atoms of the mercury in the glass tube 401, so that ultraviolet rays are radiated. And, this ultraviolet ray excites the fluorescent material coated on the inner surface of the glass tube 401 to allow visible light to be emitted, so that the cold-cathode tube lamp emits light.

Incidentally, if the above cold-cathode tube lamp continues to be used for a long time, ions and the like collide with the electrode, so that a phenomenon (sputtering phenomenon) in which atoms are emitted from a metal material that constitutes the electrode occurs. If a sputtering phenomenon occurs, atoms (sputtered matter) of the electrode metal emitted by the sputtering combine with mercury filled in the glass tube; accordingly, a disadvantage that mercury used for the discharge is consumed occurs. As described above, if mercury is consumed, the radiation of ultraviolet rays becomes less, the light emission becomes weak, and the brightness of the lamp becomes low. According to this, there is a problem that the life of the cold-cathode tube lamp becomes short. Besides, in a case of a cup-shape electrode, the collision of ions and the like easily occurs on a bottom-portion inner surface of the electrode in a concentrated fashion; accordingly, through-holes appear through the bottom portion of the electrode, and in some cases, the electrode comes off, so that the electrode is likely to be broken.

To resolve the electrode breakdown caused by the above sputtering, for example, there is a method for mounting a reinforcement member on the electrode (e.g., a patent document 1). The patent document 1 describes a structure of a cold-cathode type electrode that is composed of: a cylindrical metal body; a reinforcement member mounted on an inner-side bottom-surface portion of the cylindrical metal body; and a space portion. Accordingly, because it is possible to increase a thickness of the cylindrical metal body by forming the reinforcement member on the inner-side bottom-surface portion of the cylindrical metal body, it is possible to alleviate the inner-side bottom-surface portion of the cylindrical metal body being damaged by the sputtering. According to this, it is possible to alleviate occurrence of a disadvantage and the like that the electrode comes off the sealed metal body.

[patent document 1]: JP-A-2002-289135

### DISCLOSURE OF THE INVENTION

### Problems to be Solved by the Invention

However, in the electrode described in the above patent document 1, because the reinforcement member is formed in the inner-side bottom-surface portion of the electrode, sputtered matter that is generated by collision of the ions and the like with the reinforcement member easily scatters from the electrode into the glass tube. Because the sputtered matter that scatters into the glass tube easily combines with mercury in the glass tube, a disadvantage that mercury is consumed occurs. According to this, there are problems that the brightness of the cold-cathode tube lamp becomes low, and the life of the cold-cathode tube lamp becomes short.

Incidentally, in recent years, less power consumption, a longer life, higher efficiency and the like of a backlight are required. For example, to raise light emission efficiency, it is known that a gas pressure in a glass tube is lowered and a large current is flown. However, if the gas pressure in the glass tube is lowered, a moving speed of the ions and the like becomes fast; accordingly, there are problems that sputtering easily occurs and the life of the cold-cathode tube lamp becomes short because of the sputtering. To resolve such problems, for example, a method for enlarging a tube diameter of the glass tube is thought of.

However, in a case where the tube diameter of the glass tube is enlarged, if an electrode that has the same size as the conventional one, a distance between an inner wall of the glass tube and the electrode becomes large, so that ions and the like collide with not only the bottom-portion inner surface and inside surface of the electrode but also the outside surface of the electrode. Accordingly, there are problems that sputtering easily occurs and breakdown of the electrode caused by the sputtering easily occurs. Besides, if the tube diameter of the glass tube is enlarged and the size of the electrode is enlarged, the inner diameter of the electrode also becomes large, so that ions and the like easily collide with the bottom-portion inner surface and the inside surface of the electrode. Accordingly, there are problems that sputtering occurs in a concentrative fashion on the bottom-portion inner surface and an inside surface near the bottom portion of the electrode; and breakdown of the electrode caused by the sputtering easily occurs. Further, if the inner diameter of the electrode becomes large, sputtered matter generated by the sputtering can easily scatter from the electrode into the glass tube; accordingly, there are problems that the sputtered matter combines with mercury in the glass tube and the mercury is consumed.

Besides, in a case where the size of the electrode is enlarged as described above, a load on a lead terminal that supports the electrode becomes large, so that there is a possibility that deformation and breakdown of the lead terminal occur at a connection portion of the lead terminal and the electrode. Besides, because a heat generation amount of the electrode also increases by enlarging the electrode, there are possibilities that a disadvantage that light emission efficiency becomes low because of the heat generation; and the heat generated at the electrode concentrates on the lead terminal, so that there is a possibility that a lamp base connected to the lead terminal and a nearby connector are subjected to thermal damage.

The present invention has been made to solve the above problems, and it is an object of the present invention is to provide a cold-cathode tube lamp that is able to increase stability of an electrode, a lighting device for a display device, a display device and a television receiving device.

### Means for Solving the Problem

To achieve the above object, the present invention includes: a glass tube in which at least a rare gas is filled; a pair of first electrodes that are disposed to face each other at both inner end portions of the glass tube and composed of a first cylinder-shape cylindrical portion that has an opening portion at one end and a first bottom portion that closes the other end of the first cylindrical portion; and a second electrode that is disposed in each of the first electrodes; wherein the second electrode has a second cylinder-shape cylindrical portion that has an opening portion at least one end; and the second electrode is disposed in such a way that the second cylindrical portion is away from the first cylindrical portion of the first electrode by a predetermined distance.

According to the above structure, because the cold-cathode tube lamp according to the present invention includes the second electrode disposed in the first electrode, a discharge area becomes large and current densities in the first electrode and the second electrode become low. According to this, it becomes possible to alleviate occurrence of sputtering. Besides, because ions and the like in the glass tube collide with not only the first electrode but also the second electrode, it is possible to alleviate concentrative occurrence of sputtering on one electrode. According to this, because it is possible to alleviate the electrode being broken by sputtering, it is possible to alleviate the life of the cold-cathode tube lamp becoming short.

Besides, the first electrode includes the first cylinder-shape cylindrical portion that has the opening portion at one end and the first bottom portion that closes the other end of the first cylindrical portion, while the second electrode has the second cylinder-shape cylindrical portion that has the opening portion at least one end; the second electrode is disposed in such a way that the second cylindrical portion is away from the first cylindrical portion of the first electrode by the predetermined distance; accordingly, it is possible to alleviate occurrence of sputtering in a concentrative fashion on the first bottom-portion inner surface and a nearby inside surface. According to this, because it is possible to alleviate the first electrode being broken by the sputtering, it is possible to alleviate the life of the cold-cathode tube lamp becoming short. Besides, because sputtered matter generated by the sputtering collides with the second cylindrical portion of the second electrode, it becomes possible to alleviate the sputtered matter scattering into the glass tube. According to this, it is possible to alleviate mercury being consumed because of combination of the sputtered matter with the mercury, so that it is possible to alleviate the life of the cold-cathode tube lamp becoming short because of consumption of the mercury.

Besides, in the cold-cathode tube lamp having the above structure, the second electrode may further have a second bottom portion that closes the other end of the second cylindrical portion.

In this case, it is preferable that the second electrode is disposed in such a way that the second bottom portion butts against the first bottom portion of the first electrode. According to such structure, it becomes possible to unitarily form the first electrode and the second electrode in the same process; accordingly, even if the second electrode is formed in the first electrode to alleviate the electrode being broken by sputtering, it is possible to alleviate increase of production manpower. According to this, it is possible to alleviate the production process becoming onerous.

Besides, in the cold-cathode tube lamp having the above structure, it is preferable that the second electrode is formed concentrically with the first electrode. According to such structure, so that the predetermined distance between the first cylindrical portion of the first electrode and the second cylindrical portion of the second electrode becomes equal, the second electrode is disposed in the first electrode; accordingly, it is possible to easily alleviate concentrative occurrence of sputtering on the first bottom portion of the first electrode. According to this, because it is possible to alleviate breakdown of the electrode, it is possible to alleviate the life of the cold-cathode tube lamp becoming short.

Besides, in the cold-cathode tube lamp having the above structure, it is preferable that an outer diameter of the second cylindrical portion of the second electrode is 0.1 to 0.8 times of an outer diameter of the first cylindrical portion of the first electrode. According to such structure, because it is possible to easily alleviate concentrative occurrence of sputtering on the bottom portion of either of the first electrode and the second electrode, it is possible to alleviate the first electrode or the second electrode being broken by the sputtering. According to this, it is possible to alleviate the life of the cold-cathode tube lamp becoming short.

Besides, in the cold-cathode tube lamp having the above structure, it is preferable that a length of the second cylindrical portion of the second electrode is 0.5 to 1.0 times of a length of the first cylindrical portion of the first electrode. According to such structure, it is possible to alleviate ions and the like colliding with a tip end portion of the second cylindrical portion of the second electrode in a concentrative fashion. Besides, because a step is formed between the second cylindrical portion of the second electrode and the first cylindrical portion of the first electrode, it becomes hard for sputtered matter generated in the first electrode and the second electrode to scatter into the glass tube. According to this, it is possible to alleviate the life of the cold-cathode tube lamp becoming short because of combination of the sputtered matter with the mercury.

Besides, in the cold-cathode tube lamp having the above structure, it is preferable that an inner diameter of the glass tube is 3 mm or longer. According to such structure, because it is possible to enlarge the tube diameter of the cold-cathode tube lamp, it is possible to secure a sufficient amount of light and raise light emission efficiency by flowing a large current into the cold-cathode tube lamp.

Besides, in the cold-cathode tube lamp having the above structure, it is preferable that total gas pressure of the rare gas filled in the glass tube is 50 Torr or lower. According to such structure, it is possible to raise the light emission efficiency.

Besides, in the cold-cathode tube lamp having the above structure, it is preferable that a plurality of lead terminals one end of which is connected to the first electrode and the other end of which is led out to outside of the glass tube are disposed on each first electrode. According to such structure, even in a case where the size of the first electrode is large, because it is possible to surely support the first electrode with a good balance and reduce a load on one lead terminal, it is possible to alleviate deformation and breakdown of the lead terminal occurring at a connection portion of the first electrode and the lead terminal. According to this, it is possible to alleviate the life of the cold-cathode tube lamp becoming short because of breakdown of the electrode.

Besides, even in a case where the heat generation amount increases by enlarging the size of the first electrode, the generated heat is radiated from each of the plurality of lead terminals, so that it is possible to alleviate a disadvantage and the like that the heat generated at the first electrode propagates to the glass tube and the tube-wall temperature of the glass tube rises; and because of this, the mercury reabsorbs ultraviolet rays emitted. According to this, it becomes possible to alleviate the light emission efficiency becoming low. Besides, because the heat generated at the first electrode is radiated from each of the plurality of lead terminals, it is possible to alleviate a disadvantage that the heat concentrates on any of the lead terminals; and because of this, a lamp base connected to the lead terminal and a nearby connector are damaged.

Besides, to achieve the above object, a lighting device for a display device according to the present invention includes the above cold-cathode tube lamp.

According to the above structure, by including the above cold-cathode tube lamp, the lighting device for a display device is able to alleviate the life of the cold-cathode tube lamp becoming short because of sputtering; accordingly, it is possible to alleviate a disadvantage and the like that the life of the cold-cathode tube lamp becomes short; and because of this, brightness of the lighting device for a display device becomes low.

Besides, to achieve the above object, a display device according to the present invention includes the above lighting device for a display device.

According to the above structure, because the display device includes the above lighting device for a display device, it is possible to alleviate a disadvantage and the like that the life of the cold-cathode tube lamp becomes low; and because of this, brightness of the display device becomes low; accordingly, it is possible to raise reliability of the display device.

Besides, to achieve the above object, a television receiving device according to the present invention includes the above display device.

According to the above structure, because the television receiving device includes the above display device, it is possible to alleviate a disadvantage and the like that the life of the cold-cathode tube lamp becomes low; and because of this, the brightness of the display device becomes low; accordingly, it is possible to raise reliability of the television receiving device.

### ADVANTAGES OF THE INVENTION

As described above, according to the present invention, it is possible to provide a cold-cathode tube lamp, a lighting device for a display device, a display device and a television receiving device that use the cold-cathode tube lamp.

### BRIEF DESCRIPTION OF THE DRAWINGS

FIG. 1 is a sectional view showing a structure of a cold-cathode tube lamp according to a first embodiment.

FIG. 2 is a sectional view of an enlarged part of the cold-cathode tube lamp shown in FIG. 1.

FIG. 3 is a sectional view along a 500-500 line shown in FIG. 1.

FIG. 4 is a sectional view showing a structure of a cold-cathode tube lamp according to a second embodiment.

FIG. 5 is a sectional view along a 600-600 line shown in FIG. 4.

FIG. 6 is a schematic view of a lighting device for a display device according to a third embodiment.

FIG. 7 is a sectional schematic view along a 700-700 line shown in FIG. 5.

FIG. 8 is an exploded perspective view of a liquid crystal display device according to a fourth embodiment.

FIG. 9 is a sectional view showing a structure of a cold-cathode tube lamp according to a modification.

FIG. 10 is a sectional view showing a structure of a cold-cathode tube lamp according to a modification.

FIG. 11 is a sectional view showing a conventional electrode for a cold-cathode tube lamp.

### LIST OF REFERENCE SYMBOLS

[11] glass tube
[21, 22] first electrodes
[21a, 22a] first cylindrical portions
[21b, 22b] first bottom portions
[31, 32, 33, 34] lead terminals
[41, 42] second electrodes
[41a, 42a] second cylindrical portions
[41b, 42b] second bottom portions
[100, 110] cold-cathode tube lamps
[200] lighting device for display device
[300] liquid crystal display device

### BEST MODE FOR CARRYING OUT THE INVENTION

### First Embodiment

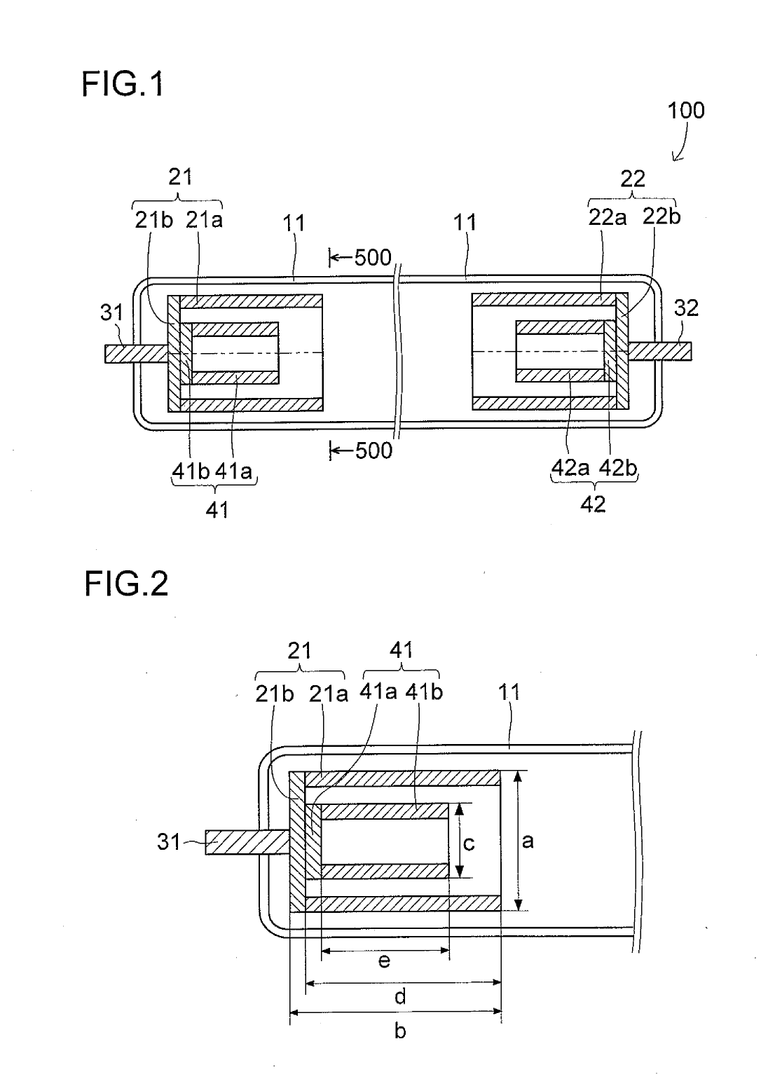

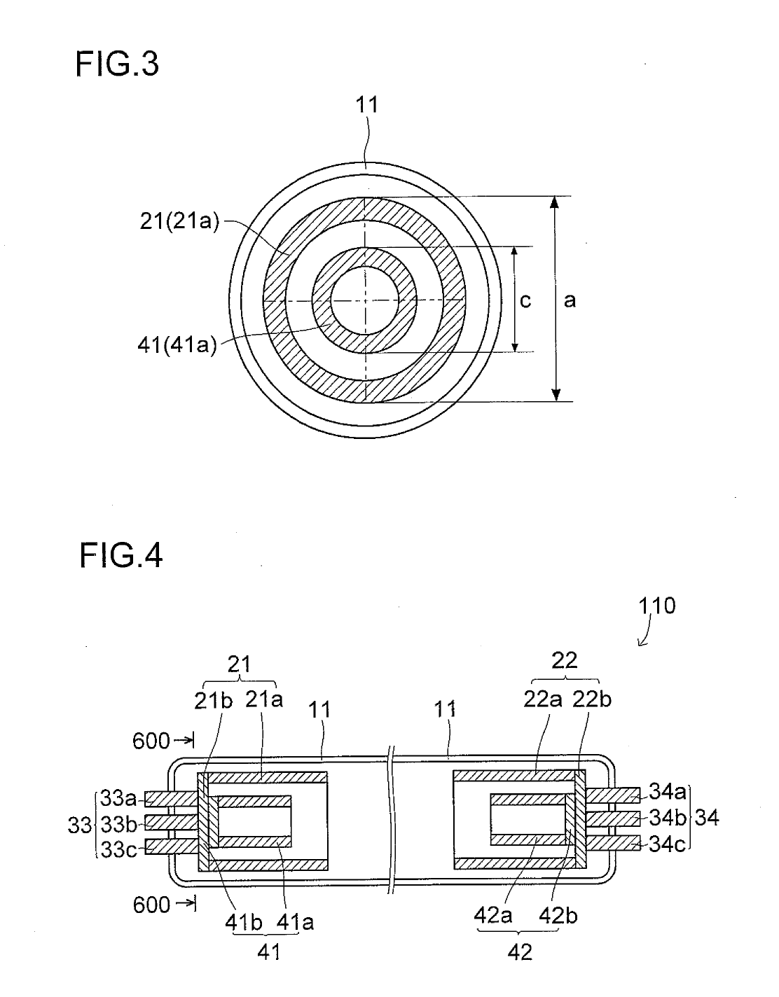

FIG. 1 is a sectional view showing a structure of a cold-cathode tube lamp 100 according to a first embodiment. FIG. 2 is a sectional view of an enlarged part of the cold-cathode tube lamp 100 according to the first embodiment shown in FIG. 1. FIG. 3 is a sectional view along a 500-500 line shown in FIG. 1. First, the structure of the cold-cathode tube lamp 100 according to the first embodiment is described with reference to FIGS. 1 to 3.

The cold-cathode tube lamp 100 according to the first embodiment, as shown in FIGS. 1 and 2, includes a discharge tube that is composed of: a glass tube 11 that has an outer diameter of 4 mm to 20 mm, preferably, 3 mm to 10 mm, and an inner diameter of at least 3 mm or longer, preferably, 4 mm or longer; and an electrode 21 and an electrode 22 that constitute a pair of cold cathodes disposed at both inner end portions of the glass tube 11. Each of the electrode 21 and the electrode 22, as described in FIGS. 1 and 2, has a cup shape that is composed of: a cylinder-shape cylindrical portion 21a and a cylinder-shape cylindrical portion 22a that have each an opening portion at one end; and a bottom portion 21b and a bottom portion 22b that close the other end of each of the cylindrical portion 21a and the cylindrical portion 22a.

In the first embodiment, outer diameters (a) of the electrode 21 and the electrode 22 are each 2 mm to 10 mm, preferably, 2 mm to 3.5 mm; and total lengths (b) of the electrode 21 and the electrode 22 are each 4 mm to 20 mm, preferably, 4 mm to 10 mm. Besides, a ratio value of the outer diameter (a) of the electrode to the total length (b) of the electrode, that is, a/b=0.5 to 1. Here, in the first embodiment, the electrode 21 and the electrode 22 are made of nickel (Ni) and formed by pressing or the like. Besides, the electrode 21 and the electrode 22 are examples of a “first electrode” of the present invention; and the cylindrical portion 21a and the cylindrical portion 22a are examples of a “first cylindrical portion” of the present invention. Besides, the bottom portion 21b and the bottom portion 22b are examples of a “first bottom portion” of the present invention.

As shown in FIG. 1, a lead terminal 31 and a lead terminal 32 are connected to the electrode 21 and the electrode 22, respectively. The other end of each of the lead terminal 31 and the lead terminal 32 is led out to outside of the glass tube 11; and the glass tube 11 is closed air-tightly and sealed hermetically by the lead terminal 31 and the lead terminal 32. Besides, although not shown, a fluorescent material is coated on an inner wall of the glass tube 11. Further, a mixed gas of argon and neon, and also mercury are filled in the glass tube 11 in such a way that total gas pressure becomes 50 Torr or lower, preferably, 40 Torr. Here, in the first embodiment, the lead terminal 31 and the lead terminal 32 are made of nickel (Ni) and welded to the electrode 21 and the electrode 22, respectively. Besides, outer diameters of the lead terminal 31 and the lead terminal 32 are each 0.6 mm to 0.8 mm.

In the first embodiment, as described above, the discharge tube that is composed of: the glass tube 11 that has the inner diameter (f) of 3 mm or longer; and the pair of electrodes 21 and 22 that have the outer diameter (a) of 2 mm to 10 mm and the total length (b) of 4 mm to 20 mm is included; and the mixed gas of argon and neon is filled in such a way that the total gas pressure of the rare gases become 50 Torr or lower, so that it becomes possible to raise brightness and improve light emission efficiency of the cold-cathode tube lamp 100 by flowing a large current into the cold-cathode tube lamp 100.

Besides, in the first embodiment, as shown in FIGS. 1 to 3, an electrode 41 and an electrode 42 are disposed in the electrode 21 and the electrode 22, respectively. Each of the electrode 41 and the electrode 42, as described in FIGS. 1 and 2, has a cup shape that is composed of: a cylinder-shape cylindrical portion 41a and a cylinder-shape cylindrical portion 42a that have each an opening portion at one end; a bottom portion 41b and a bottom portion 42b that close the other end of each of the cylindrical portion 41a and the cylindrical portion 42a. In the first embodiment, as shown in FIGS. 1 to 3, the electrode 41 and the electrode 42 are disposed in such a way that the cylindrical portion 41a of the electrode 41 and the cylindrical portion 42a of the electrode 42 are by a predetermined distance away from the cylindrical portion 21a of the electrode 21 and the cylindrical portion 22a of the electrode 22, respectively; and disposed in such a way that the bottom portion 41b of the electrode 41 and the bottom portion 42b of the electrode 42 butt against the bottom portion 21b of the electrode 21 and the bottom portion 22b of the electrode 22, respectively.

Besides, in the first embodiment, as shown in FIGS. 1 to 3, the electrode 41 and the electrode 42 are disposed concentrically with the electrode 21 and the electrode 22, respectively. Here, the electrode 41 and the electrode 42 are made of the same metal material (Ni) as the electrode 21 and the electrode 22; and are formed in such a way that the ratio of the outer diameter (c) of the electrode 41 and the electrode 42 to the outer diameter (a) of the electrode 21 and the electrode 22, that is, c/a=0.1 to 0.8. Besides, in the first embodiment, the electrode 21 and the electrode 41, and the electrode 22 and the electrode 42 may be unitarily formed by pressing or the like; or the electrode 21 and the electrode 22 and the electrode 41 and the electrode 42 are separately formed, then, the electrode 21 and the electrode 41, and the electrode 22 and the electrode 42 may be formed by welding. Here, the electrode 41 and the electrode 42 are examples of a “second electrode”; the cylindrical portion 41a and the cylindrical portion 42a are examples of a “second cylindrical portion” of the present invention. Besides, the bottom portion 41b and the bottom portion 42b are examples of a “second bottom portion” of the present invention.

In the first embodiment, as shown in FIGS. 1 and 2, the cylindrical portion 41a and the cylindrical portion 42a of the electrode 41 and the electrode 42 are formed not to protrude beyond the cylindrical portion 21a and the cylindrical portion 22a of the electrode 21 and the electrode 22, respectively. According to this, it is possible to alleviate ions and the like in the glass tube 11 colliding with tip end portions of the cylindrical portion 41a and the cylindrical portion 42a in a concentrative fashion; and it is possible to easily alleviate sputtered matter, which is generated by collision of the ions and the like with the tip end portions of the cylindrical portion 41a and the cylindrical portion 42a of the electrode 41 and the electrode 42, scattering into the glass tube 11. Besides, because steps are formed between the cylindrical portion 21a of the electrode 21 and the cylindrical portion 41a of the electrode 41 and between the cylindrical portion 22a of the electrode 22 and the cylindrical portion 42a of the electrode 42, sputtered matter generated in the electrodes 21, 41 and the electrodes 22, 42 is easily blocked, so that it is possible to easily alleviate the sputtered matter scattering into the glass tube 11. According to this, it is possible to alleviate a disadvantage that the sputtered matter combines with mercury; and because of this, the mercury is consumed; accordingly, it is possible to alleviate a disadvantage that the mercury decreases; and because of this, the life of the cold-cathode tube lamp becomes short. Here, in the first embodiment, a ratio value the length (e) of the cylindrical portion 41a and the cylindrical portion 42a of the electrode 41 and the electrode 42 to the length (d) of the cylindrical portion 21a and the cylindrical portion 22a of the electrode 21 and the electrode 22, that is, e/d=0.5 to 1.0.

In the first embodiment, as described above, because the electrode 41 and the electrode 42 are formed in the electrode 21 and the electrode 22, respectively, a discharge area becomes large and current densities become low. According to this, it is possible to easily alleviate occurrence of sputtering. Besides, because ions and the like generated in the glass tube 11 collide with not only the electrode 21 and the electrode 22 but also the electrode 41 and the electrode 42, it is possible to alleviate concentrative occurrence of sputtering on one electrode. Besides, because the electrode 21 and the electrode 41, and the electrode 22 and the electrode 42, as shown in FIGS. 1 to 3, are disposed concentrically and away from each other by the predetermined distance, it is possible to alleviate concentrative occurrence of sputtering on the inner surfaces of the electrodes 21, 22 and near the bottom portion 21b and the bottom portion 22b. According to this, because it is possible to alleviate the electrode 21 and the electrode 22 being broken by the sputtering, it is possible to alleviate the life of the cold-cathode tube lamp 100 becoming short.

Further, because part of the sputtered matter generated in the electrode 21 and the electrode 22 collides with the cylindrical portion 41a and the cylindrical portion 42a of the electrode 41 and the electrode 42, it becomes possible to alleviate the sputtered matter scattering into the glass tube 11. Besides, because each of the cylindrical portion 41a and the cylindrical portion 42a of the electrode 41 and the electrode 42 are formed not to protrude beyond each of the cylindrical portion 21a and the cylindrical portion 22a of the electrode 21 and the electrode 22, it becomes hard for the sputtered matter to scatter into the glass tube; accordingly, it is possible to alleviate a disadvantage that the sputtered matter combines with mercury; and because of this, the mercury is consumed. According to this, it is possible to alleviate a disadvantage that the mercury decreases; and because of this, the brightness and life of the cold-cathode tube lamp decrease.

### Second Embodiment

FIG. 4 is a sectional view showing a structure of a cold-cathode tube lamp 110 according to a second embodiment. FIG. 5 is a sectional view along a 600-600 line shown in FIG. 3. Next, the structure of the cold-cathode tube lamp 110 according to the second embodiment is described with reference to FIGS. 4, 5. Here, in the second embodiment, the same components as those in the above first embodiment are indicated by the same reference numbers and description of them is skipped.

In the second embodiment, as shown in FIG. 4, a plurality of (three) lead terminals 33 (33a, 33b, 33c) are connected to the electrode 21, while a plurality of (three) lead terminals 33 (34a, 34b, 34c) are connected to the electrode 22. The other ends of the plurality of lead terminals 33 and 34, as shown in FIG. 4, are led out to outside of the glass tube 11; and the glass tube 11 is closed air-tightly and hermetically sealed by the plurality of lead terminals 33 and 34. Here, outer diameters of the lead terminals 33, 34 are each 0.6 mm to 0.8 mm.

In the second embodiment, as shown in FIG. 5, the three lead terminals 33 (34), when viewed in a planar fashion, are disposed in such a way that a polygonal shape formed by the three lead terminals becomes an equilateral-triangle shape; and disposed in such a way that the center of gravity of the equilateral-triangle shape substantially agrees with the center of the bottom portion of the electrode 21 (22). It is possible to physically dispose the lead terminals 33 (34) with a good balance by disposing the three lead terminals 33 (34) as described above, so that even in a case where the outer diameter of the electrode 21 (22) is enlarged, it is possible to surely support the electrode 21 (22) with a good balance. Accordingly, because it is possible to reduce a load acting on each of the lead terminals 33 (34), it is possible to alleviate deformation and breakdown of the lead terminals 33 (34) occurring at the connection portion of the electrode 21 (22) and the lead terminals 33 (34). According to this, it is possible to alleviate the life of the cold-cathode tube lamp becoming short because of deformation and breakdown of the electrodes at the connection portion of the electrode and the lead terminal.

Besides, by connecting the three lead terminals 33 (34) to the electrode 21 (22), heat generated at the electrode 21 (22) is radiated from each of the three lead terminals 33 (34), so that even in a case where the heat generation amount increases by enlarging the outer diameter of the electrode 21 (22), it is possible to efficiently radiate the generated heat from each of the three lead terminals 33 (34). According to this, it is possible to alleviate a disadvantage and the like that the heat generated at the electrode 21 (22) propagates to the glass tube and the tube-wall temperature of the glass tube rises; and because of this, the mercury reabsorbs ultraviolet rays emitted; accordingly, it becomes possible to alleviate the light emission efficiency becoming low. Besides, the heat generated at the electrode 21 (22) is radiated from each of the three lead terminals 33 (34), so that it is possible to alleviate a disadvantage that the heat concentrates on any one of the lead terminals 33 (34); and because of this, a lamp base connected to the lead terminals 33 (34) and a nearby connector are damaged.

Here, the other structures of the second embodiment are the same as the first embodiment.

### Third Embodiment

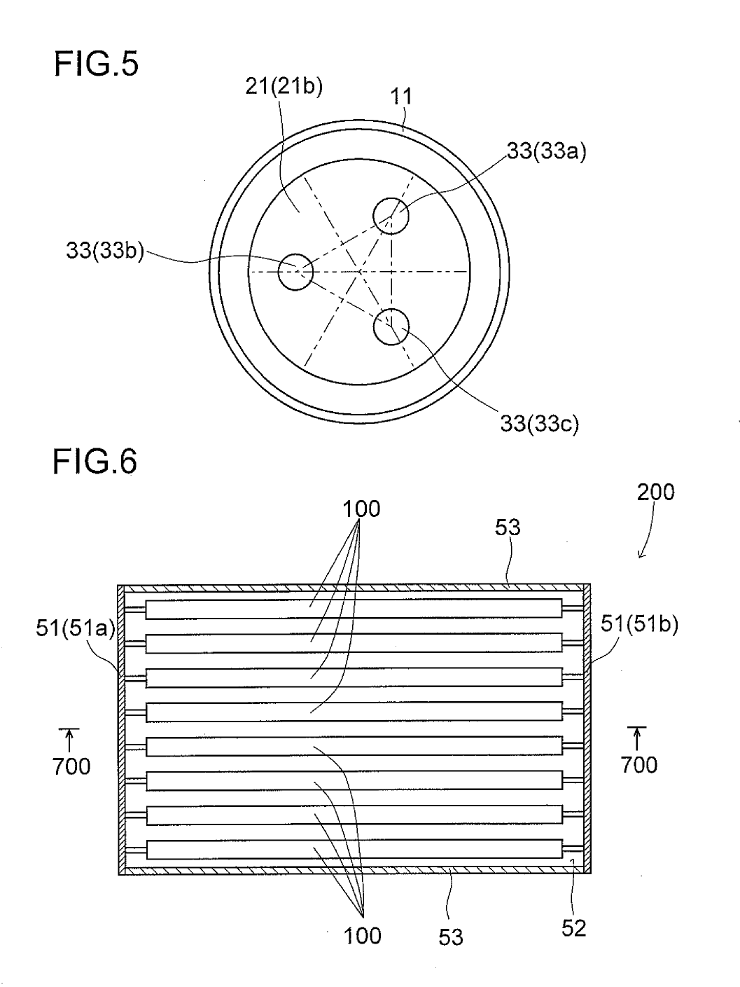

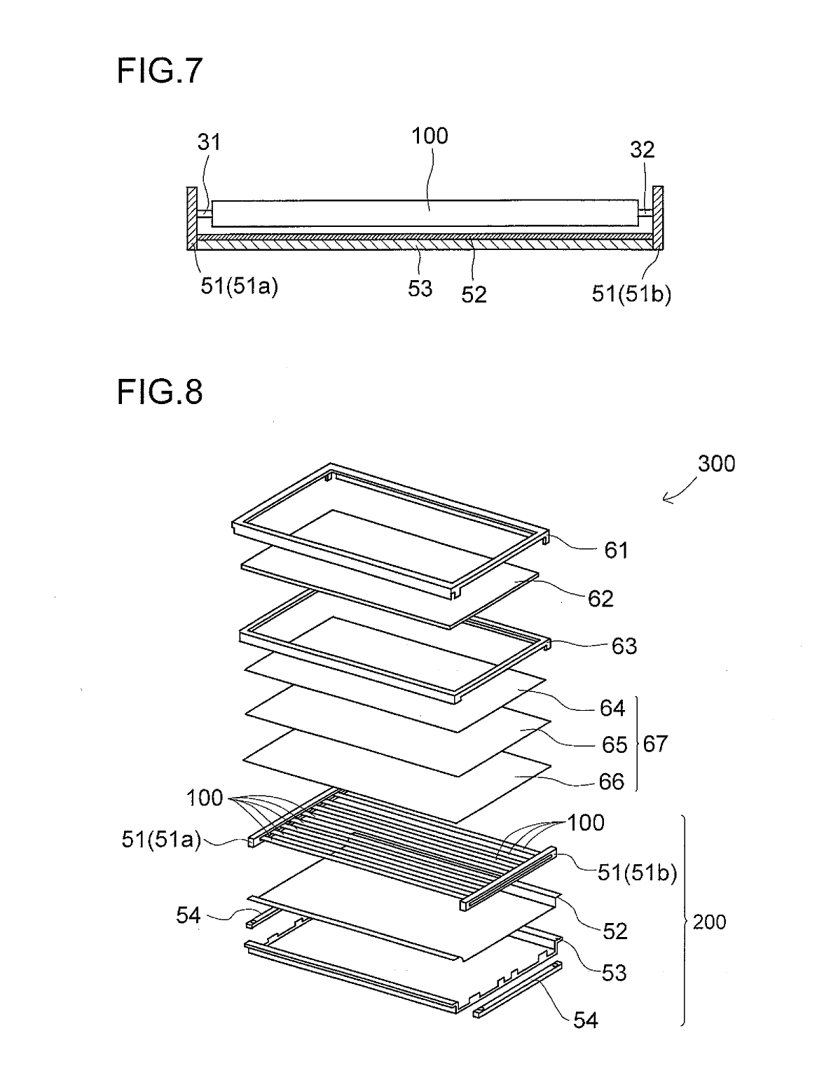

FIG. 6 is a schematic view of a lighting device 200 for a liquid crystal display device that uses the cold-cathode tube lamp 100 according to the first embodiment. FIG. 7 is a sectional schematic view along a 700-700 line shown in FIG. 6. Next, the lighting device 200 for a display device according to the third embodiment is described with reference to FIGS. 6, 7. Here, in the third embodiment, the same components as those in the above first embodiment are indicated by the same reference numbers and description of them is skipped.

The lighting device 200 for a display device, as shown in FIG. 6, includes: a discharge-tube group composed of a plurality of cold-cathode tube lamps 100 that are disposed in parallel; a cold-cathode tube lamp holding member 51 (51a, 51b) that holds the plurality of cold-cathode tube lamps 100 of the discharge-tube group; a reflective complex member 52 that is disposed under the discharge-tube group to reflect light that is radiated downward from the discharge-tube group; and a back chassis 53 that fixes the discharge-tube group. The cold-cathode tube lamp holding members 51 (51a, 51b), as shown in FIGS. 6 and 7, are disposed at opposite positions to hold the lead terminals 31 and 32 of each of the plurality of cold-cathode tube lamps 100. In this way, the plurality of cold-cathode tube lamps 100 are collectively positioned and held by the cold-cathode tube lamp holding members 51 (51a, 51b). The reflective complex member 52 is composed, for example, of: a metal plate made of aluminum or the like; and a resin reflective sheet attached on an upper surface of the metal plate. The back chassis 53 has roles in closing the discharge-tube group, maintaining the strength of the lighting device for a display device, and radiating heat that is generated from the discharge-tube group (cold-cathode tube lamp 100). Here, although not shown, an optical-sheet group 67 described later is disposed on an upper surface of the discharge-tube group, that is, at a position in front of the reflective complex member 52.

The plurality of cold-cathode tube lamps 100, as shown in FIG. 6, are disposed in parallel; the lead terminal 31 and the lead terminal 32 of the cold-cathode tube lamp 100, as shown in FIG. 7, are held by the clod-cathode tube lamp holding member 51a and the clod-cathode tube lamp holding member 51b, respectively. A power-supply device, not shown, is disposed on a rear surface of the back chassis 53; and the clod-cathode tube lamp holding members 51 (51a, 51b) are electrically connected to the power-supply device directly or via a connector or the like. According to this, opposite-phase alternating voltages are applied to the electrode 21 and the electrode 22 (see FIG. 1) of the cold-cathode tube lamp 100 via the respective lead terminal 31 and lead terminal 32, so that each cold-cathode tube lamp 100 emits light. According to this, the lighting device 200 for a display device emits light.

Because the lighting device 200 for a display device according to the third embodiment, as described above, includes the cold-cathode tube lamp 100 according to the first embodiment of the present invention, decrease in the life of the cold-cathode tube lamp caused by sputtering is alleviated. According to this, it becomes possible to alleviate a disadvantage and the like that brightness of the lighting device for a display device becomes low because of decrease in the life of the cold-cathode tube lamp.

### Fourth Embodiment

FIG. 8 is an exploded perspective view of a liquid crystal display device 300 that includes the lighting device 200 for a display device according to a fourth embodiment. Next, the liquid crystal display device 300 according to the fourth embodiment is described with reference to FIG. 8. Here, in the fourth embodiment, the same components as those in the above first and third embodiments are indicated by the same reference numbers and description of them is skipped.

The liquid crystal display device 300, as shown in FIG. 8, includes, over the lighting device 200 for a display device according to the third embodiment: an optical-sheet group 67; a liquid crystal panel 62 that displays an image; a front chassis 63 that fixes the liquid crystal panel 62; and a bezel 61 that protects the liquid crystal panel 62. The optical-sheet group 67 is composed of resin sheets that perform diffusion, collection and the like of transmitted light; and, for example, from the top layer, a diffusion sheet 64, a prism sheet 65 and a diffusion sheet 66 are laminated and disposed. Here, it is possible to arbitrarily change the number and combination of sheets of the optical-sheet group 67. The bezel 61 includes a frame shape that has a reversed L shape in section; and opening portions are formed at positions that correspond to insertion portions formed on outside surfaces of the cold-cathode tube lamp holding members 51 (51a, 51b). The front chassis 63 includes a frame shape that has a reversed L shape in section; and like the bezel 61, opening portions are formed at positions that correspond to insertion portions formed on outside surfaces of the cold-cathode tube lamp holding members 51 (51a, 51b). According to this, the bezel 61, the liquid crystal panel 62, the front chassis 63, the optical-sheet group 67 and the lighting device 200 for a display device are mounted.

In the fourth embodiment, as described above, the lighting device 200 for a display device that includes the cold-cathode tube lamp 100 is disposed on a rear surface of the liquid crystal panel 62; and each of the other constituent members is disposed, so that light emitted from the cold-cathode tube lamp 100 is output to the liquid crystal panel 62 side. According to this, it becomes possible to display an image and the like on the liquid crystal panel 62.

Because the display device 300 according to the fourth embodiment, as described above, includes the lighting device 200 for a display device that includes the cold-cathode tube lamp 100, it is possible to alleviate a disadvantage and the like that brightness of the display device 300 becomes low because of decrease in the life of the cold-cathode tube lamp 100. According to this, it is possible to raise reliability of the display device 300.

Here, in the fourth embodiment, the liquid crystal display device is described; however, this is not limitative, and the cold-cathode tube lamp may be applied to a display device other than the liquid crystal display device.

Besides, the liquid crystal display device according to the fourth embodiment is able to be used for a television receiving device, for example. A television receiving device according to the present invention includes, for example: a ground-wave antenna; a television receiving tuner; an output portion; a keyboard; a storage portion; a GPS receiving antenna: a television receiving portion; a GPS receiving portion; and a control portion. The liquid crystal display device according to the fourth embodiment is able to be used as a display that outputs an image signal and a sound signal that are converted by a MPEG 2 decoder or an image/sound decoder, and forms the output portion together with a speaker and the like.

Because the television receiving device includes the display device 300 according to the fourth embodiment, it is possible to alleviate a disadvantage and the like that brightness of the display device 300 becomes low because of decrease in the life of the cold-cathode tube lamp 100 that is used in the lighting device 200 for a display device of the display device 300. According to this, it is possible to raise reliability of the television receiving device.

Here, it should be thought that the embodiments disclosed this time are examples in all respects and not limitative. The scopes of the present invention are not represented by the description of the above embodiments but by the claims and further read on all modifications within the meaning equivalent to the claims.

For example, in the above first to fourth embodiments, the structure in which the mixed gas of argon and neon is filled in the glass tube is described as an example; however, this is not limitative, and a rare gas other than argon and neon may be filled. Specifically, there are xenon and krypton.

Besides, in the above first to fourth embodiments, the electrode that is made of nickel (Ni) is described as an example; however, this is not limitative, and a metal material other than nickel (Ni) may be used. Specifically, there are metal materials, for example, such as niobium (Nb), molybdenum (Mo), tungsten (W) and the like.

Besides, in the above first to fourth embodiments, the lead terminal that is made of nickel (Ni) is described as an example; however, this is not limitative, and a lead terminal that is made of a metal material other than nickel (Ni) may be used. As metal materials other than nickel (Ni), there are, for example, copper (Cu), tungsten (W) and the like. Here, the electrode and the lead terminal may be made of the same metal material or may be made of different metal materials.

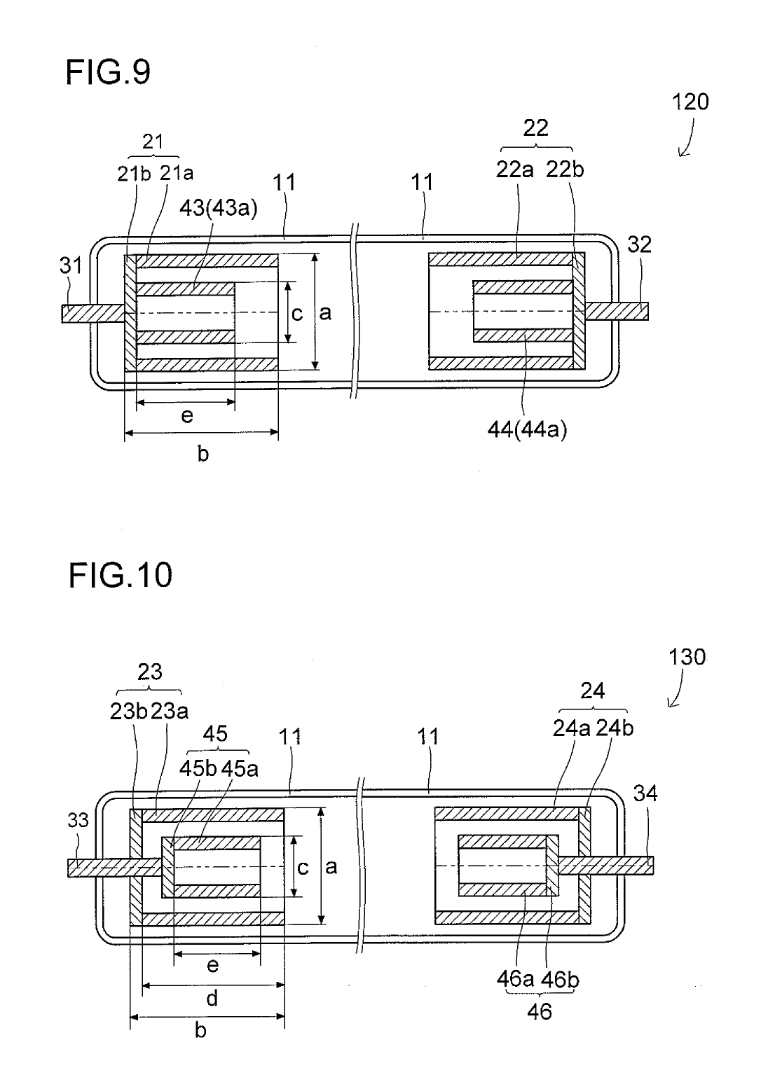

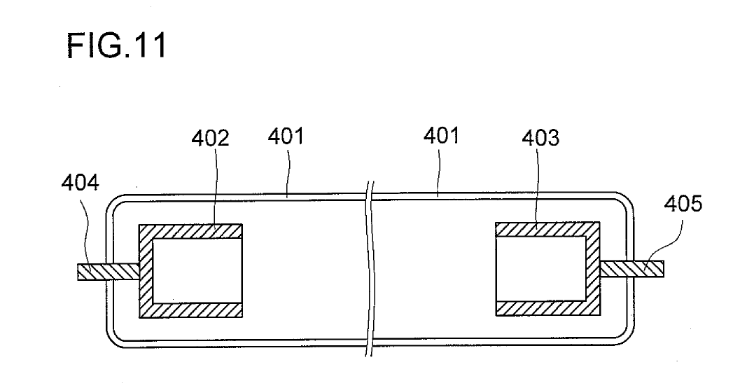

Besides, in the above first and second embodiments, the second electrode that is composed of the second cylinder-shape cylindrical portion that has the opening portion at one end and the second bottom portion that closes the other end of the second cylindrical portion is described as an example; however, this is not limitative, and as shown in FIG. 9, the second electrode that is composed of the second cylinder-shape cylindrical portion only that has the opening portion at one end may be used.

Besides, in the above first and second embodiments, the structure in which the second electrode is disposed in such a way that the second bottom portion of the second electrode butts against the first bottom portion of the first electrode is described as an example; however, this is not limitative, and as shown in FIG. 10, the structure may be employed, in which the second electrode is disposed in such a way that the second bottom portion of the second electrode is away from the first bottom portion of the first electrode by a predetermined distance.

Besides, in the above second embodiment, the structure in which the three lead terminals are used is described as an example; however, this is not limitative, and at least two or more lead terminals are sufficient as the plurality of lead terminals. Besides, the shape formed by the lead terminals may not be a regular-polygonal shape; and it is sufficient if the lead terminals are disposed in such a way that the center of gravity of a polygonal shape formed by the lead terminals substantially agrees with the center of the bottom portion of the electrode. Besides, the shape formed by the lead terminals may not be a polygonal shape; and it is sufficient if the lead terminals are disposed in such a way that at lest two lead terminals of the plurality of lead terminals are disposed at opposite positions with respect to the center of the bottom portion of the electrode when viewed in a planar fashion. Further, one lead terminal of the plurality of lead terminals may be disposed at the center of the bottom portion of the electrode.

Besides, in the above third and fourth embodiments, the structure in which the cold-cathode tube lamp according to the first embodiment is used is described as an example; however, this is not limitative, and it is possible to employ a structure which uses any cold-cathode tube lamps represented by the claims inclusive of the cold-cathode tube lamp according to the second embodiment and the cold-cathode tube lamps according to modifications of the present invention.

Besides, in the above fourth embodiment, a type in which the lighting device for a display device that includes the cold-cathode tube lamp is disposed on the rear-surface side of the liquid crystal panel, that is, a direct type is described as an example; however, this is not limitative, and an edge light type in which the lighting device for a display device that includes the cold-cathode tube lamp is disposed on an end portion side of the liquid crystal panel may be used.

1. A cold-cathode tube lamp comprising:
a glass tube in which at least a rare gas is filled;
a pair of first electrodes that are disposed to face each other at both inner end portions of the glass tube and composed of a first cylinder-shape cylindrical portion that has an opening portion at one end and a first bottom portion that closes the other end of the first cylindrical portion; and
a second electrode that is disposed in each of the first electrodes, wherein
the second electrode has a second cylinder-shape cylindrical portion that has an opening portion at least one end, and
the second electrode is disposed in such a way that the second cylindrical portion is away from the first cylindrical portion of the first electrode by a predetermined distance.

2. The cold-cathode tube lamp according to claim 1, wherein the second electrode further has a second bottom portion that closes the other end of the second cylindrical portion.

3. The cold-cathode tube lamp according to claim 2, wherein the second electrode is disposed in such a way that the second bottom portion butts against the first bottom portion of the first electrode.

4. The cold-cathode tube lamp according to claim 1, wherein the second electrode is formed concentrically with the first electrode.

5. The cold-cathode tube lamp according to claim 1, wherein an outer diameter of the second cylindrical portion of the second electrode is 0.1 to 0.8 times of an outer diameter of the first cylindrical portion of the first electrode.

6. The cold-cathode tube lamp according to claim 1, wherein a length of the second cylindrical portion of the second electrode is 0.5 to 1.0 times of a length of the first cylindrical portion of the first electrode.

7. The cold-cathode tube lamp according to claim 1, wherein an inner diameter of the glass tube is 3 mm or longer.

8. The cold-cathode tube lamp according to claim 1, wherein total gas pressure of the rare gas filled in the glass tube is 50 Torr or lower.

9. The cold-cathode tube lamp according to claim 1, wherein a plurality of lead terminals one end of which is connected to the first electrode and the other end of which is led out to outside of the glass tube are disposed on each first electrode.

10. A lighting device for a display device comprising the cold-cathode tube lamp according to claim 1.

11. A display device comprising the lighting device for a display device according to claim 10.

12. A television receiving device comprising the display device according to claim 11.
